(19) United States
(12) Patent Application Publication
(10) Pub. No.: US 2023/0280122 A1
(43) Pub. Date: Sep. 7, 2023

(54) REMOTE TRIGGER FOR PYROTECHNIC ENERGY RELEASES

(71) Applicant: RUAG Ammotec GmbH, Fürth (DE)

(72) Inventors: Henning Rost, Erlangen (DE); Andreas Winter, Fürth (DE)

(21) Appl. No.: 18/110,212

(22) Filed: Feb. 15, 2023

(30) Foreign Application Priority Data
Feb. 15, 2022 (DE) 10 2022 103 535.2

(51) Int. Cl. F41A 19/60

(52) U.S. Cl. CPC F41A 19/60; F42B 4/24

(57) ABSTRACT

The present invention relates to a method for providing a predetermined pyrotechnic energy output to a pyrotechnic separating device for separating an electrical line, such as a cable, a wire, a conductor path or the like, leading to an electrical energy source, such as a battery or an accumulator, for outputting and/or receiving electrical energy, in which: a temperature of or in the vicinity of the electrical energy source is detected; and, when the detected temperature exceeds a predetermined temperature threshold, the pyrotechnic separating device is remotely activated to separate the electrical line at a location spatially remote from the electrical energy source.

The present invention relates to a method and a system for remotely triggering a pyrotechnic energy output, for example, for activating pyrotechnic separating devices arranged to separate an electrical line, such as a cable, a wire, a conductor path or the like, leading to an electrical energy source, such as a battery, a galvanic cell or an accumulator, for outputting/or receiving electrical energy.

Such pyrotechnic separating devices are configured to separate an electrical charging coupling between an electrical energy source and an electrical energy supply or an electrical discharging coupling between a preferably chargeable energy source and an electrical load. For example, such a pyrotechnical separating device is intended to prevent overheating on electronic devices, in particular of the battery, which can lead to damage to the electronic device. Such batteries have an output power of significantly more than 1 ampere, in particular in a range from 1 ampere to 70 ampere, in particular in a range from 10 ampere to 50 ampere, in particular in a range from to ampere to 30 ampere, or in a range from 30 ampere to 50 ampere, or in a range from 50 ampere to 70 ampere, for example 45 ampere, 35 ampere or 40 ampere.

Pyrotechnic separating devices can also be configured in such a way that they can be used to separate an electrically conductive conductor path leading to or provided in a carrier for electronic components, in particular a circuit board, circuit card, or plate, in order to dissipate and/or receive the electrical energy. Such pyrotechnic separating devices as well as a system for providing a pyrotechnic energy output for activating pyrotechnic separating devices are known from the German application DE 102019126192 B3 of the applicant, the contents of which, in particular with regard to the operation and the structure of the pyrotechnic separating devices, are fully incorporated herein by reference.

It has been found that the electrical cables of the electronic component to be monitored and possibly overheated are not always accessible or are at least difficult to reach, for example, due to installation space-related reasons. In motor vehicles, for example, there are often various electrical and electronic components whose overheating requires an extremely fast shutdown of the electrical energy source in order to prevent dangerous chain reactions. It is usually not possible to change the available installation space, in particular not by relocating the electronic components. In the prior art, there are no solutions for setting up emergency shutdown mechanisms for electronic components that are difficult or impossible to access, or for electronic components or for electric components, for which it is not possible to cut their electrical cables or conductor paths directly in the area of the electronic component itself, in particular because of limited installation space.

One objective of the present invention is to overcome the disadvantages of the prior art, in particular to reliably ensure pyrotechnic energy output independent of the installation space.

This objective is solved by the subject matter of the independent claims.

According to a first aspect of the present invention, a method for providing a predetermined pyrotechnic energy output of preferably at least 0.5 J to a pyrotechnic separating device for separating an electrical line, such as a cable, a wire, a conductor path or the like, leading to an electrical energy source, such as a battery or an accumulator, for outputting and/or receiving electrical energy, is provided. Pyrotechnic energy outputs are used, for example, in pyrotechnic separating devices, pyrotechnic switching devices or actuation devices, which are arranged to separate, cut, punch through, damage or the like an electrical line, such as a cable, a wire, a conductor path or the like, leading to an electrical energy source, such as a battery, a galvanic cell or an accumulator, for outputting and/or receiving electrical energy. Such pyrotechnic separating devices are configured to separate an electrical charging coupling between an electrical energy source and an electrical energy supply, or an electrical discharging coupling between a preferably chargeable energy source and an electrical load. For example, the pyrotechnic separating device is intended to prevent overheating on electronic devices, in particular on batteries, such as lithium ion batteries, which can lead to damage to the electronic device. Such batteries can provide a current strength of significantly more than 1 A, in particular in a range from 1 A to 70 A, in particular in a range from 10 A to 50 A, in particular in a range from 10 A to 30 A or a range from 30 A to 50 A, or in a range from 50 A to 70 A, for example 45 A, 35 A or 40 A. Pyrotechnic separating devices can also be configured such that they can be used to separate an electrically conductive conductor path leading to or provided in a carrier for electronic components, in particular a circuit board, circuit card or plate, for outputting and/or receiving electrical energy. Generic Pyrotechnic separating devices are known from German application DE 10 2019 101 430.1 of the same applicant, the contents of which, particularly with respect to the operation and structure of pyrotechnic separating devices, are fully incorporated herein by reference.

In the method according to the invention, a temperature of the electrical energy source or in its vicinity is detected. Insofar as the temperature is detected in the vicinity of the electrical energy source, this may mean a temperature value that is detected in the immediate vicinity of the energy source or is, in any case, related in some way to the temperature of the energy source to be monitored. The location of the temperature measurement may be referred to as the measurement location. For example, a pyrotechnic temperature sensor performs the temperature measurement.

Furthermore, according to the method according to the invention, the pyrotechnic separating device is remotely activated when the detected temperature exceeds a predetermined temperature threshold in order to separate the electrical line at a location spatially remote, in particular at a separating location, from the electrical energy source, in particular the measurement location. The exceeding of the predetermined temperature threshold can be understood as a condition or trigger parameter for the remote activation of the pyrotechnic separating device. The predetermined temperature threshold may be an energy source-specific temperature threshold, a temperature threshold specifically adapted to an electronic device to which the energy source is assigned or determined for the environment of the energy source, which is expected to cause critical chain reactions when reached. For example, the temperature threshold may be selected such that it is reduced by a safety percentage, such as in the range of 1% to 30%, below the critical maximum temperature for the energy source or the temperature measured in the environment of the energy source. The basic idea of the present invention lies in the separation of measurement and cutting, in particular in the separation of measurement location and cutting location. The method according to the invention makes it possible to monitor possibly overheated energy sources, which are installed, for example, in electronic components, and to also reliably separate them from the energy supply when they overheat, for example, if the electrical line of the corresponding energy source is not directly accessible at the energy source itself or at the location where the temperature is detected, for example due to installation space-related reasons. In this respect, the system according to the invention makes it possible to reliably separate energy sources and/or electrical devices in the event of overheating, irrespective of the available installation space and the installation space conditions. Remote activation can thus be understood to mean, among other things, that a signal transmission of some kind takes place in dependence of the detected temperature between the measurement location and the cutting location defined by the pyrotechnic separating device.

In an exemplary embodiment of the method according to the invention, the remote activation is performed by a, in particular non-electrical pyrotechnic, chain reaction. The chain reaction may, for example, be purely pyrotechnic. In this respect, the method according to the invention does not require its own energy source and can thus be operated in an energy-efficient manner and, above all, is also effective in the states which may be critical for the energy sources of electrical components in the event of energy supply failures.

According to a further exemplary embodiment of the method according to the invention, a pyrotechnic initial conversion occurs under an exothermic chemical initial reaction when the detected temperature exceeds a predetermined temperature threshold. Under exothermic chemical reaction generally a reaction is meant to which less energy is supplied for its activation than the reaction releases or delivers in energy. For example, a pyrotechnic material may be provided that pyrotechnically converts at a material-specific conversion temperature.

Preferably, pyrotechnic materials are provided whose conversion temperatures are significantly above 100° C., in particular above 110° C., 120° C., 130° C., 140° C., 150° C., or even above 170° C., 200° C., 220° C. or above 250° C., in particular above 300° C. For example, the potassium salt of 1,4-dihydro-5,7-dinitrobenzofurazan-4-ol 3-oxide (in short: potassium dinitrobenzofuroxanate, K-benzanate, or KDNBF), K/Ca 2,4,6-trinitrobenzene-1,3-bis(olate) (in short: Potassium/calcium styphnate, K/CaStyp) or lead 2,4,6-trinitroresorcinate (in short: lead trizinate, lead styphnate, trizinate) are used as components of the pyrotechnic material. The mentioned substances can be used in mixtures with other components. The melting point or decomposition point of, for example, pure KDNBF is approx. 170° C. in mixtures of KDNBF with selected components, the deflagration temperatures can be controlled in the range of 150° C. to 160° C., and the deflagration temperatures of the mixtures can be lower than those of the individual components. Other suitable materials can be found in the applicant's German publication DE 102006060145 A1. Furthermore, primary explosives can be used individually or in combination with additives to achieve higher efficacy. Examples include Diazodinitrophenol (in short: diazole, dinol, or DDNP), salts of styphinic acid (such as K/Ca 2,4,6-trinitrobenzene-1,3-bis(olate) (in short: potassium/calcium styphnate, K/CaStyp) or lead 2,4,6-trinitroresorcinate (in short: Lead trizinate, lead styphnate, trizinate)), tetrazene, salts of dinitrobenzofuroxanate, 1-(2,4,6-trinitrophenyl)-5-(1-(2,4,6-trinitrophenyl)-1H-tetrazol-5-yl)-1 H-tetrazole (in short: picrazole), or N-methyl-N-2,4,6-tetranitroaniline (in short: Tetryl). For example, K/Ca 2,4,6-trinitrobenzene-1,3-bis(olate) (in short: potassium/calcium styphnate, K/CaStyp) can be used as a pyrotechnic material. Other suitable pyrotechnic materials are described, for example, in the publication EP 1 890 986 B1, which is based on the international patent application WO 2006/128910 and the German patent applications DE 10 2005 025 746 and DE 10 2006 013 622, which are intended to be incorporated by reference into the disclosure content of the present invention.

The pyrotechnic initial conversion may be performed in accordance with the method described in DE 10 2019 126192 B3, which is incorporated herein by reference in its entirety.

According to an exemplary further development of the method according to the invention, the pyrotechnic initial conversion causes a pyrotechnic transfer conversion under an exothermic chemical subsequent reaction. In other words, the pyrotechnic initial conversion triggers a downstream pyrotechnic transfer conversion. Pyrotechnic material may also be provided for the pyrotechnic initial conversion, which may be selected according to the above embodiment. The pyrotechnic transfer conversion occurs with a time offset ΔT₁ from the pyrotechnic initial conversion.

In another exemplary further development of the method according to the invention, the pyrotechnic transfer conversion causes a pyrotechnic ignition conversion of the pyrotechnic separating device to trigger the pyrotechnic separating device. In other words, the pyrotechnic transfer conversion initiates the activation of the pyrotechnic separating device by causing a pyrotechnic ignition conversion to be associated with the pyrotechnic separating device. Pyrotechnic material may be provided for the pyrotechnic ignition conversion, which, for example, belongs to the pyrotechnic separating device, which may further be selected according to the above description. The pyrotechnic ignition conversion therefore occurs with a time offset ΔT₂ to the pyrotechnic transfer conversion.

By the method according to the invention, a pyrotechnic chain reaction is given in this respect to ultimately activate the pyrotechnic separating device for separating the electrical line.

According to another aspect of the present invention, which is combinable with the preceding aspects and exemplary embodiments, there is provided a system for providing a predetermined pyrotechnic energy output, in particular of at least 0.5 J, to a pyrotechnic separating device for separating an electrical line, such as a cable, a wire, a conductor path or the like, leading to an electrical energy source, such as a battery or an accumulator, for outputting and/or receiving electrical energy. Furthermore, systems according to the invention can be used, for example, to provide a pyrotechnic energy output for a pyrotechnic separating device for separating an electrical charging coupling or an electrical discharging coupling between an electrical energy source and an electrical load. Pyrotechnic energy outputs are used, for example, in pyrotechnic separating devices arranged to separate an electrical line, such as a cable, wire, conductor path, or the like, leading to an electrical energy source, such as a battery or accumulator, for outputting and/or receiving electrical energy. Such pyrotechnic separating devices are configured to separate an electrical charging coupling between an electrical energy source and an electrical energy supply, or an electrical discharging coupling between a preferably chargeable energy source and an electrical load. For example, the pyrotechnic separating device is intended to prevent overheating on electronic devices, in particular of batteries such as lithium ion batteries, which may result in damage to the electronic device. Such batteries can provide a current strength of significantly over 1 A, in particular up to 10 A or 50 A. Pyrotechnic separating devices can also be designed such that they can be used to separate an electrically conductive conductor path leading to or provided in a carrier for electronic components, in particular a circuit board, circuit card or plate for outputting and/or receiving electrical energy.

The system according to the invention comprises a pyrotechnic igniter which is exposed to the temperature of the electrical energy source or is exposed to a temperature, in particular in the immediate vicinity of the energy source, and pyrotechnically converts at a predetermined temperature. The pyrotechnic igniter can be configured, for example, as a pyrotechnic temperature sensor. The pyrotechnic igniter may have pyrotechnic material that pyrotechnically converts when a pyrotechnic material-specific conversion temperature is reached. In other words, the pyrotechnic igniter pyrotechnically converts when the temperature to which it is exposed, in particular the temperature of the electrical energy source or a temperature in its vicinity, exceeds the pyrotechnic material-specific conversion temperature. With regard to the pyrotechnic material, reference is made to the preceding explanations.

Furthermore, the system according to the invention comprises a separate, pyrotechnic remote ignition means which is coupled to the igniter and couplable to the separating device and which is configured to transfer the heat released during the pyrotechnic conversion of the igniter to the pyrotechnic separating device. The pyrotechnic remote ignition means basically serves to provide the initial energy required to trigger the pyrotechnic separating device. The remote ignition means according to the invention therefore makes it possible to transfer the initial energy in the form of heat required to trigger the pyrotechnic separating device between two positions which are spatially offset in relation to one another, in particular between the location of the pyrotechnic igniter, in particular a measurement location, and the location of the pyrotechnic separating device, in particular a cutting location. For example, the pyrotechnic igniter is arranged at or at least in the area of the electrical energy source and the pyrotechnic separating device is arranged at a location spatially remote therefrom in the area of the electrical line to be cut. In this way, with the aid of the system according to the invention, an electronic component can be reliably and energy-efficiently monitored regardless of the available installation space and, in the event of its overheating or in the event of overheating, its energy source can be reliably switched off in order to exclude dangerous chain reactions.

In an exemplary embodiment of the system according to the invention, the remote ignition means comprises pyrotechnic material which is adjusted and/or selected in such a way that it pyrotechnically converts upon pyrotechnic conversion of the igniter in order to trigger the pyrotechnic separating device. The remote igniter may be used, for example, as a means for establishing a pyrotechnic chain reaction. With respect to the pyrotechnic material of the remote ignition means, reference may be made to the preceding embodiments. The pyrotechnic igniter can pyrotechnically convert under an exothermic pyrotechnic reaction and thereby ignite the pyrotechnic material of the remote ignition means, so that this pyrotechnic material pyrotechnically converts again under an exothermic chemical reaction, so that the heat released during the exothermic pyrotechnic reaction of the pyrotechnic material in the remote ignition means can be used to trigger the pyrotechnic separating device, in particular for the pyrotechnic conversion of pyrotechnic material associated with the pyrotechnic separating device. In this respect, the system according to the invention does not require an electrical energy supply and/or electrical energy transmission means, which may be susceptible to faults. Furthermore, the pyrotechnic chain reaction is characterized by an extremely fast signal transmission, so that it is possible to react instantaneously to too high temperatures of the energy source or the electronic component to be monitored.

According to another exemplary further development of the system according to the invention, the remote ignition means can be triggered non-electrically. For example, the remote ignition means is formed as an ignition cord or as an ignition hose. In the case where the remote ignition means is formed as an ignition hose, an inner side of the ignition hose may be coated with pyrotechnic material, in particular with an amount in the range of 5 mg/m length of the ignition hose to 100 mg/m length, in particular in the range of 10 mg/m length to 85 mg/m length or in the range of 15 mg/m length to 70 mg/m length. The ultra-thin layer of pyrotechnic material may be adapted to convert extremely rapidly and to transmit, for example, at a speed of about 2,000 m/s, the hot reaction front resulting from the exothermic chemical reaction. According to an alternative embodiment of the remote ignition means as ignition cord, there may further be provided a protective tube encasing the ignition cord which ensures that the burning of the ignition cord does not damage any surrounding components. Another advantage of the small amount of pyrotechnic material required in the remote ignition means is that both the ignition hose or detonation hose and its surroundings remain completely undamaged. When selecting the quantity of pyrotechnic material in the ignition hose, it must be ensured that the final quantity of energy in the form of heat that can be transferred to the pyrotechnic separating device is sufficient to activate the pyrotechnic separating device, in particular to pyrotechnically convert the pyrotechnic material associated with the pyrotechnic separating device.

According to another aspect of the present invention, which is combinable with the foregoing aspects and exemplary embodiments, a pyrotechnic separating system comprising a system according to any of the previously described aspects or exemplary embodiments is provided for providing a predetermined pyrotechnic energy output to a pyrotechnic separating device for separating an electrical line, such as a cable, a wire, a conductor path, or the like, leading to an electrical energy source, such as a battery or an accumulator, for outputting and/or receiving electrical energy, and a pyrotechnic separating device coupled to the remote ignition means for cutting the electrical line.

The pyrotechnic separating device can be configured to separate an electrical charging coupling between an electrical energy source and an electrical energy supply or an electrical discharging coupling between a preferably chargeable energy source and an electrical load. For example, the pyrotechnic separating device according to the invention is intended to prevent overheating on electronic devices, in particular of batteries, such as lithium ion batteries, which can lead to damage to the electronic device. Such batteries have an output power of significantly over 1 A, in particular up to 10 A or 50 A. The pyrotechnic separating device according to the present invention can also be used to separate an electrically conductive conductor path leading to or provided in a carrier for electronic components, in particular a circuit board, circuit card or plate, for outputting and/or receiving electrical energy.

According to an exemplary further development of the separation system according to the invention, the pyrotechnic separating device has a housing with pyrotechnic material which is sealed with respect to the remote ignition means in such a way that the seal is broken in particular exclusively during the pyrotechnic conversion of the igniter, in particular of the remote ignition means. Accordingly, the seal can be set in such a way that it is temporarily removed, in particular exclusively in reaction to the pyrotechnic conversion of the remote ignition means, so that the heat generated as a result of the exothermic reaction during the pyrotechnic conversion of the remote ignition means, in particular the hot reaction front, can pass the seal and enter the housing of the pyrotechnic separating device, in particular in order to trigger the pyrotechnic conversion of the pyrotechnic material associated with the pyrotechnic separating device there. The seal can, for example, be configured in such a way that a fluid flow is only permitted in one direction. In particular, fluid flow from the housing into the remote ignition means is prevented. For example, the seal is a check valve, such as a closing element biased into the closed/sealed position, in particular a spring biased closing element, such as a ball, a cone, a flap or a membrane.

According to another exemplary further development of the separation system according to the invention, the seal is configured in such a way that when the pyrotechnic separating device is triggered, the seal is rebuilt, in particular a fluid flow from the housing of the pyrotechnic separating device in the direction of the remote ignition means is prevented. The seal can be realized, for example, by a check valve. This prevents the high internal pressure that builds up inside the housing as a result of the pyrotechnic conversion of the pyrotechnic material of the pyrotechnic separating device from being transmitted to the remote ignition means and, in particular, causing damage there.

In an exemplary embodiment of the pyrotechnic separating system, the pyrotechnic separating device comprises a cut mechanism for cutting the electrical line and a pyrotechnic drive for operating the cut mechanism, which is associated with the pyrotechnic drive in such a way that, upon activation of the pyrotechnic drive, the cut mechanism is driven, particularly wherein the pyrotechnic drive is equipped with a material that pyrotechnically converts as a function of temperature.

Preferably, the cut mechanism can operate without electrical or electronic equipment and can cut the electrical line by performing mechanical work. Furthermore, the pyrotechnic separating device can have a pyrotechnic drive for operating the cut mechanism. For example, the pyrotechnic drive may be configured to perform the mechanical work to cut the electrical line by the cut mechanism utilizing the pyrotechnic effect of the pyrotechnic drive. In an exemplary embodiment, the cut mechanism is associated with the pyrotechnic drive such that the cut mechanism is driven or operated when the pyrotechnic drive is activated. In particular, the cut mechanism separates the electrical line when the pyrotechnic drive is activated. Accordingly, the pyrotechnic separation device according to the present invention utilizes the pyrotechnic effect to provide the cut mechanism with a driving or actuating force by means of which the cut mechanism can perform mechanical work to separate the electrical line. According to an exemplary embodiment, the pyrotechnic drive is directly coupled to the cut mechanism, in particular no power transmission means are arranged between the pyrotechnic drive and the cut mechanism. In particular, this allows the pyrotechnic drive to operate the cut mechanism transmission-free. According to an alternative embodiment, the pyrotechnic drive can be coupled to the cut mechanism by means of a gear for preferably transmission-free transfer of a driving force generated by the pyrotechnic drive to the cut mechanism. For example, it can be provided that a transmission gear is interposed between the pyrotechnic drive and the cut mechanism in order to increase or decrease the drive force generated by the pyrotechnic drive. Any gear or transmission gear can be used for this purpose. The pyrotechnic drive may further comprise a preferably pressure-, liquid- and/or gas-tight chamber having pyrotechnic material. However, the chamber may, if desired, have a defined, in particular semi-permeable, gas permeability, preferably only to the inside. The chamber is intended to contain the pyrotechnic material. The choice of pyrotechnic material or pyrotechnic set or pyrotechnic substance depends in particular on the field of application (the desired pyrotechnic energy conversion) as well as on the dimensioning of the chamber and the type of cut mechanism used. In the pyrotechnic separating device according in the invention, the pyrotechnic material accommodated in the chamber is configured and/or can be controlled in such a way that it develops its pyrotechnic effect in particular only when a predetermined operating state is reached. In this context, the operating state can be a specific state of the energy source and/or the electrical energy supply and/or the electrical load. In a preferred embodiment, the pyrotechnic material is configured to convert only when the predetermined operating state is reached, which can be adjusted by the choice of the specific material of the pyrotechnic material. Preferably, the determinable trigger parameter is the temperature to which the pyrotechnic material is exposed. Alternatively, the deployment at the predetermined operating state may be achieved by an added control in which the trigger parameter is selected to be independent of temperature, for example by a corresponding electrical control signal, which in turn may depend on a measurand such as temperature, pressure, humidity, velocity, acceleration. An example of a pyrotechnic material that is activated when a certain thermal operating state is reached is the so-called pyrotechnic early ignition means. In this respect, an operating parameter dependent on the temperature prevailing at the pyrotechnic material is essential. In particular, the pyrotechnic material should be set in such a way that, when it is converted or ignited, such a large pyrotechnic conversion takes place, which releases thermal energy that the cut mechanism can cut the electrical line. It was shown that with the pyrotechnic separating device according to the invention it is possible to ensure immediate electrical separation with the highest probability when undesired critical charging and/or outputting processes are reached, irrespective of the technical field of application and/or the type of device, in particular when used with lithium-ion batteries with an output power of up to 50 A. In a preferred embodiment, the pyrotechnic material is selected such that it triggers when a trigger temperature defined with respect to a critical operating state of, for example, above 50°, 70°, 80°, 90°, 100° or above 110° is exceeded in order to communicate the driving force of the cut mechanism. In a further development of the present invention, the chamber has a total internal volume at least partially enclosed by a chamber housing. Of the total internal volume, the pyrotechnic material occupies more than 20% or 30% and not more than 90% or 80% or 70% or 60% or 50%. The volume region free of the pyrotechnic material may be filled with gas, such as air, for example. The volume ratio between the occupancy of the pyrotechnic material and the free gas space in the chamber can be used to adjust the conversion of the pyrotechnic material. The following substances, materials and mixtures can be used to form a preferred pyrotechnic material, although it is clear that the individual substances mentioned can also be used in combination with each other or individually. For example, the chamber accommodates the cut mechanism at least axial sectionally. In this context, the axial direction is to be understood as the longitudinal extension direction of the chamber and/or an actuation direction of the cut mechanism, in which the cut mechanism is operated when the pyrotechnic drive is activated. In a further development, the housing guides the cut mechanism, in particular at least the axial section of the cut mechanism received in the chamber, in a pressure-tight, liquid-tight and/or gas-tight sliding manner during activation of the pyrotechnic drive, in particular without the gases expanding during conversion of the pyrotechnic drive leaving the chamber. In the embodiment of the pyrotechnic separating device with a gear, the chamber can be part of the gear and, in addition to housing the pyrotechnic material that initiates the pyrotechnic activation, can also provide an axial guide for the cut mechanism, which is operated, in particular driven, as a result of the pyrotechnic activation of the pyrotechnic drive. Furthermore, the cut mechanism can perform an axial relative movement with respect to the chamber when the pyrotechnic drive is converting. This means that the pyrotechnic drive, when activated, can cause the cut mechanism to perform an axial relative movement in order to be displaced in the direction of the electrical line to be cut, in order to cut it as a result of the axial relative movement. Accordingly, the driving force generated by the pyrotechnic drive is converted into a movement of the cut mechanism, whereby the cut mechanism experiences a kinetic energy that is sufficient to separate the electrical line. In particular, the conversion of the pyrotechnic material located in the chamber leads to the operation, in particular driving, of the cut mechanism, in particular due to a gas expansion accompanying the conversion of the pyrotechnic material. For example, the cut mechanism can have an actuating component, such as a piston or a plunger, arranged at least axial sectionally in a chamber of the pyrotechnic drive occupied by pyrotechnic material, wherein in particular the chamber is formed according to one of the exemplary embodiments described above. Preferably, the actuating component is sealed and slidably guided within the chamber so as to ensure that, upon conversion of the pyrotechnic drive, the gas expansion associated with the conversion of the pyrotechnic material cannot cause the gases to escape from the chamber. All gases should be sealed off within the chamber. For example, the actuation component may be configured to receive forces, such as driving forces, that occur during activation of the pyrotechnic drive, particularly during conversion of the pyrotechnic material, and to communicate those forces, particularly to the cut mechanism. In particular, the actuation component is part of the gear and is preferably directly interposed between the pyrotechnic drive and an effective cutting component of the cut mechanism in such a way that the drive force is converted into a cutting force by means of the actuation component. The actuation component can be arranged in the chamber and/or associated with the pyrotechnic drive in such a way that, when the pyrotechnic drive is activated, the actuation component causes an axial movement of the cut mechanism relative to the chamber. This communicates a feed force to the cut mechanism, due to which the cut mechanism is accelerated and the electrical line is cut. The cut mechanism may comprise a cutting element, such as a preferably cylindrical ram, a blade, a mandrel or an arrowhead, for cutting the electrical line. The cylindrical ram may be implemented as a solid cylinder, for example. Exemplary diameter dimensions of the cylindrical ram, are in the range of 0.2 mm to 1 mm, to ensure reliable separation of the electrical line. According to an exemplary further development, the cutting element is associated with the actuating component in such a way that the cutting element is actuated, in particular operated, preferably driven, by the actuating component when the pyrotechnic drive is activated, causing in particular an axial movement of the cutting element relative to the cut mechanism housing. For example, the cutting element is provided on a side of the cut mechanism facing away from the pyrotechnic drive, and thus on the side facing the electrical line. Depending on the design of the cutting element, the cutting element cuts, splits or crushes the electrical line when the pyrotechnic drive is activated, in any case ensuring that an output and/or reception of electrical energy by means of the electrical line is interrupted. A housing of the cut mechanism, in particular configured according to one of the exemplary embodiments described previously, may comprise a through-channel for passing the electrical line to be separated. The cut mechanism, in particular the actuating component and/or the cutting element, is/are positioned with respect to the through-channel such that in a deactivated state of the pyrotechnic drive the electrical line can be passed through the through-channel unimpeded and in an activated state of the pyrotechnic drive the cut mechanism is displaced into the through-channel such that the cut mechanism cuts the electrical line. The deactivated state of the pyrotechnic drive is to be considered as the state in which the electrical energy source can output and/or receive energy by means of the electrical line. In the activated state of the pyrotechnic drive, its activation has caused an initiation of the pyrotechnic separating device, in which the cut mechanism, in particular the cutting element, has an axial movement imposed on it to cut, split or crush the electrical line. Alternatively or additionally, a housing of the cut mechanism may have a through-channel for passing the electrical line therethrough and the axial movement of the cut mechanism, in particular the actuating component and/or the cutting element, initiated by the activation of the pyrotechnic drive, in particular pyrotechnic conversion of the pyrotechnic material, can be set in such a way that, in a deactivated state, the electrical line can be passed through the through-channel unhindered and, in an activated state, the cut mechanism is displaced in the axial direction in such a way that the cut mechanism, in particular the cutting element, cuts, splits or crushes the electrical line. For example, a wire dimension, such as a wire thickness, a distance to be bridged between the cut mechanism and the electrical line in the deactivated state of the pyrotechnic drive, as well as generally a resistance force of the electrical line against a cutting can be taken into account as setting parameters. The through-channel may be dimensioned and/or the axial relative movement of the cut mechanism may be matched to a through-channel dimension such that an inner wall of the through-channel acts as an abutment when the electrical line is cut. It is provided, for example, that after the electrical line has been cut, the cut mechanism abuts against the inner wall of the through-channel, which ensures in particular that the electrical line cannot deflect the cut mechanism, which could prevent the electrical line from being cut. The pyrotechnic drive may be provided with a pyrotechnic material that converts as a function of temperature, which is arranged in particular in a chamber of the pyrotechnic drive. The chamber and the pyrotechnic material may, for example, be formed analogously to at least one of the exemplary embodiments described above. The pyrotechnic material may pyrotechnically convert, in particular ignite, upon activation of the pyrotechnic drive. Upon its conversion, the pyrotechnic material generates a thermal and/or mechanical effect, resulting in heat and/or gas pressure, which initiates an axial movement of the cut mechanism. In particular, the pyrotechnic material exceeds a predetermined activation temperature for activating the pyrotechnic drive.

In a further exemplary embodiment of the pyrotechnic separating system, the coupling of remote ignition means and pyrotechnic separating device and/or the coupling of remote ignition means and ignition means is realized by a force-fitting, material-fitting and/or form-fitting connection technology. For example, a tight-fitting toothing, keyways or toothed coupling etc., a screw connection, wedging or plugging etc. and/or soldering, welding or gluing etc. are possible.

According to another aspect of the present invention, which is combinable with the preceding aspects and exemplary embodiments, a pyrotechnic remote ignition system is provided. The remote ignition system comprises a plurality of pyrotechnic temperature sensors associated with an electrical energy source, such as a battery or an accumulator, or a plurality of electrical energy sources connected to a common electrical line carrying electrical energy. The remote ignition system further comprises a pyrotechnic separating device spatially separated from the pyrotechnic temperature sensors and associated with an electrical line, such as a cable, a wire, a conductor path, or the like, leading to an electrical energy source, for outputting and/or receiving an electrical energy.

The pyrotechnic temperature sensor can, for example, be configured in accordance with the pyrotechnic igniter described previously.

According to the further aspect of the invention, the pyrotechnic separating device is coupled to the pyrotechnic temperature sensors by remote ignition means such that the pyrotechnic separating device is activated by one of the remote ignition means when the pyrotechnic temperature sensor associated with the remote initiation means triggers. When the pyrotechnic temperature sensor is triggered, an exothermic chemical reaction may be accompanied by a pyrotechnic conversion that is initiated, for example, in a temperature-dependent manner. In this regard, reference may be made to the preceding discussion of the pyrotechnic igniter. Accordingly, the pyrotechnic remote ignition system makes it possible for different electrical and electronic components to be monitored and separately switched off extremely quickly in the event of their individual overheating, in order to prevent chain reactions and/or damage to adjacent components. One advantage of the remote ignition system according to the invention is that it requires only a single pyrotechnic separating device and can flexibly monitor and sense various electronic components to be monitored that are arranged at different locations via the remote ignition means.

According to an exemplary embodiment of the remote ignition system according to the invention, the remote ignition system comprises at least one system configured according to the invention for providing a pyrotechnic energy output and/or a pyrotechnic separating system configured according to the invention.

Preferred embodiments are given in the subclaims.

In the following, further properties, features and advantages of the invention will become clear by means of a description of preferred embodiments of the invention with reference to the accompanying exemplary drawings, in which show:

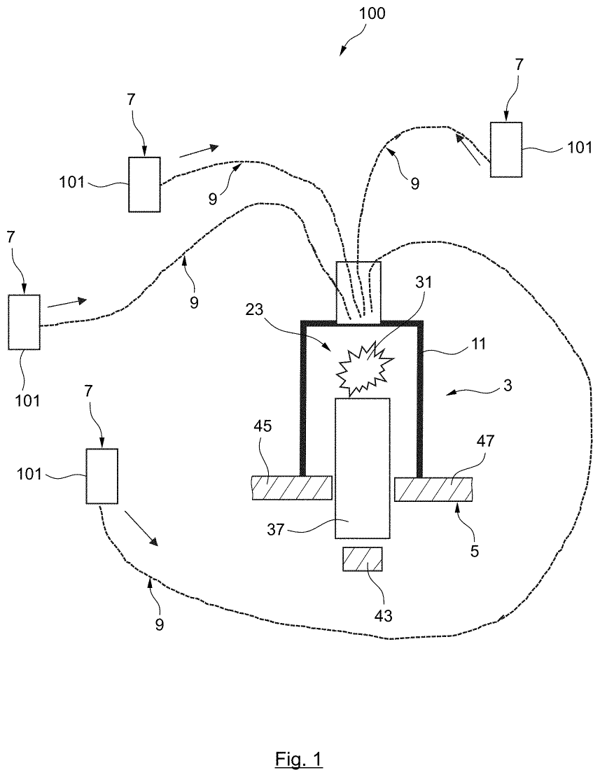

FIG. 1a schematic view of an exemplary embodiment of a pyrotechnic remote ignition system according to the invention; and

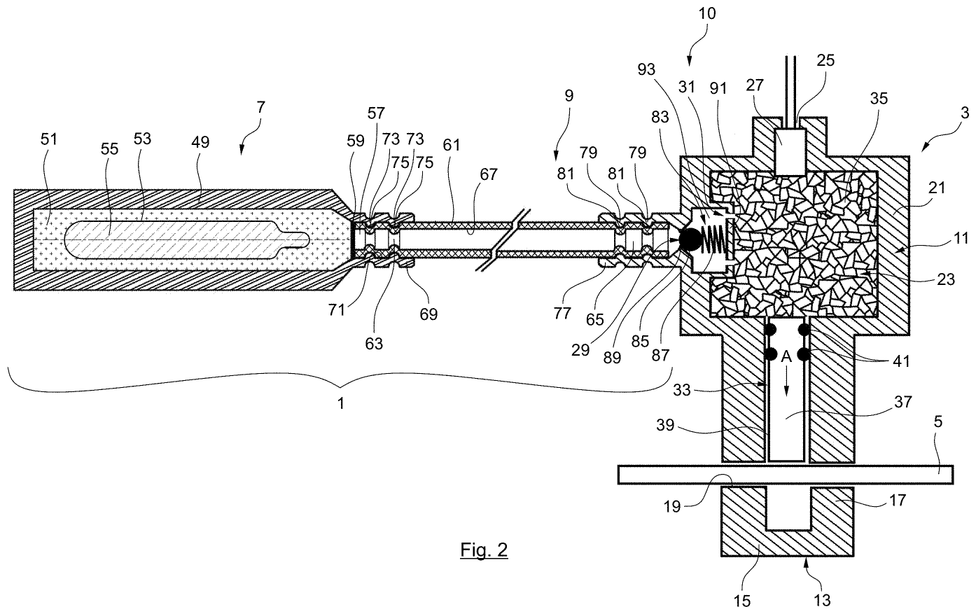

FIG. 2a schematic view of an exemplary embodiment of a pyrotechnic separating system according to the invention.

In the following description of exemplary embodiments of the invention, a system according to the invention for providing a predetermined pyrotechnic energy output to a pyrotechnic separating device is generally provided with reference numeral 1. A pyrotechnic separating system according to the invention comprising a system 1 according to the invention and a pyrotechnic separating device is generally provided with reference numeral 10, and a pyrotechnic remote ignition system according to the invention comprising a plurality of pyrotechnic temperature sensors and a separating device is generally provided with reference numeral 100.

A system 1 according to the invention is for providing a predetermined pyrotechnic energy output, preferably of at least 0.5 J, to a pyrotechnic separating device, generally provided with reference numeral 3. The separating device 3 is used to separate an electrical line 5, such as a cable, a wire, a conductor path or the like, leading to an electrical energy source (not shown), such as a battery or an accumulator, for outputting and/or receiving electrical energy. The pyrotechnic separating device 3 is configured to separate, for example, an electrical charging coupling or an electrical discharging coupling transmitted through an electrical line 5. The necessary energy for cutting the electrical line 5, is provided by means of the system 1 according to the invention.

A system 1 according to the invention comprises the following main components: a pyrotechnic igniter 7; and a pyrotechnic remote ignition means 9 coupled to the igniter 7 and couplable to the separating device 3. According to the invention, the igniter 7 is exposed to the temperature of the electrical energy source and pyrotechnically converts at a predetermined temperature. The remote ignition means 9 is configured to transfer the heat released during the pyrotechnic conversion of the igniter 7 to the pyrotechnic separating device 3 in order to trigger the pyrotechnic separating device 3 via remote activation.

With reference to FIGS. 1 and 2, the structure and mode of operation of the individual components of a system 1 according to the invention and of a separating device 3 according to the invention are explained in detail below, with FIG. 1 showing the state of the pyrotechnic separating device 3 after it has been activated or triggered and FIG. 2 showing the state of the pyrotechnic separating device 3 before it has been activated.

FIG. 1 shows an exemplary embodiment of a remote ignition system 100 according to the invention with four pyrotechnic temperature sensors 101. The temperature sensors 101 are each associated with an electrical energy source, all energy sources being connected to a common line 5. The temperature sensors 101 are each connected or coupled via a separate remote ignition means 9 to a single pyrotechnic separating device 3, which can thus be arbitrarily arranged spatially separate from the temperature sensors 101. The temperature sensors lot can each be regarded as a pyrotechnic igniter 7 according to the invention. Thus, the remote ignition system 100 in FIG. 1 comprises four separate systems 1 according to the invention, which are connected to a single separating device 3 and can each activate the same individually when the corresponding temperature sensor 101 triggers because the temperature of the corresponding energy source exceeds a predetermined temperature threshold.

FIG. 2 shows an exemplary embodiment of a pyrotechnic separating system 10, in which a system 1 according to the invention is coupled to a separating device 3 and the individual components of the system 1 and the separating device 3 are shown in detail.

The pyrotechnic separating device 3 comprises an elongated, hollow cylindrical housing 11, which is shown only schematically in FIG. 1 and in detail in FIG. 2. In the embodiment in FIG. 2, the housing 11 is closed towards a longitudinal side 13. A substantially flat bottom wall 15 is provided on the longitudinal side 13. At a distal edge section 17 adjoining the bottom wall 15, the housing 11 has a through-channel 19 oriented substantially perpendicular to the axial extent of the housing 11, through which the electrical line 5 is passed. Starting from the distal edge section 17, the housing 11 initially has a constant diameter until the housing it expands in an adjoining section 21 so that a chamber 23 is formed in the interior of the housing 11. In the embodiment shown in FIG. 2, the housing 11 has two openings in the area of the chamber 23. One opening 25 serves to receive a primer 27 which, after insertion, is enclosed by the housing 11 and completely closes the opening 25. A further opening 29 serves to connect or couple the separating device 3 to a system 1 according to the invention, which will be explained in detail later.

The separating device 3 further comprises a pyrotechnic drive 31 and a cut mechanism 33 arranged movably in the axial direction A within the housing 11 for cutting the electrical line 5. The pyrotechnic drive 31 provides the mechanical work necessary to cut the electrical line 5 and thus operates the cut mechanism 33, wherein the pyrotechnic drive 31 is utilizing the pyrotechnic effect. The pyrotechnic drive 31 includes pyrotechnic material 35 disposed in the chamber 23 and adapted to pyrotechnically convert when a predetermined ambient temperature is exceeded. The pyrotechnic conversion of the pyrotechnic material 35 generally results in a gas expansion, due to which the pressure within the housing 11 or the chamber 23 increases significantly, so that a force is exerted on the cut mechanism 33, which moves in the axial direction A relative to the housing 11 as a result of the gas expansion and in this way cuts the electrical line 5. In FIGS. 1 and 2, the cut mechanism 33 is formed as a cylindrical piston 37, which is guided by the housing 11 or a guide 39 of the housing 11 during an axial movement. To seal the chamber 23 from the guide 39 for the cut mechanism 33, two sealing rings 41 are provided between the housing 11 and the piston 37 in the embodiment shown in FIG. 2. It should be understood, however, that any conceivable means of sealing may be provided between the housing 11 and the piston 37. To seal the opening 29 in the housing 11, a check valve 83 is inserted into the opening 29, which will be explained in detail later.

As shown in FIG. 1, the cut mechanism 33 cuts the electrical line 5 by separating a line section 43 from the rest of the line 5 and moving it into the distal edge section 17 of the housing 11 (not shown in FIG. 1). If the cut mechanism 33 is made of an electrically non-conductive material, such as plastic, the cut mechanism 33 acts as a kind of insulator between the facing electrical line ends 45, 47 after the line 5 has been cut.

As an alternative to thermal activation by a specific ambient temperature, pyrotechnic drive 31 or ignition of pyrotechnic material 35 may be initiated by primer 27.

The pyrotechnic igniter 7 comprises a hollow cylindrical housing 49 filled with a reaction partner substance 51, which may comprise, for example, potassium permanganate, water and/or methanol. Also disposed within the housing 49 is an ampoule 53, for example made of glass, plastic or metal, particularly a metal alloy such as a Roses alloy, for containing a reaction substance 55, preferably comprising chemical energy. For example, the reaction substance 55 comprises glycerol, zinc powder, ammonium nitrate, ammonium chloride, and/or lithium aluminum hydride. When a predetermined temperature is exceeded, the ampoule 53 breaks or at least partially melts such that mixing of the reaction substance 55 and the reaction partner substance 51 occurs. The reaction substance 55 and the reaction partner substance 51 are configured with respect to each other in such a way that an exothermic chemical reaction is triggered when the two substances are mixed.

As an alternative to the reaction partner substance 51 and the ampoule 53 filled with the reaction substance 55, the housing 49 of the igniter 7 may contain only a pyrotechnic material that ignites at a predetermined temperature.

The housing 49 of the pyrotechnic igniter 7 has an opening 57 through which the remote ignition means 9 is connected to the pyrotechnic igniter 7. To prevent the reaction partner substance 51 from escaping from the housing 49 before the pyrotechnic igniter 7 is activated, the opening 57 is sealed with a sealing metal foil 59.

In accordance with the invention, the pyrotechnic igniter 7 is positioned in proximity to an electrical energy source to be monitored so that it is exposed to the temperature of the electrical energy source and the ampoule 53 breaks, if the energy source overheats and exceeds a predetermined temperature threshold.

In the embodiment shown in FIG. 2, the remote ignition means 9 is in the form of an ignition hose 61, one end 63 of which is connected or coupled to the electrical igniter 7 and the other end 65 of which is connected or coupled to the pyrotechnic separating device 3. The ignition hose 61 may, for example, consist of several layers of different plastics and have an outer diameter of about 3 to 5 mm. On an inner side 67 of the ignition hose 61, the ignition hose 61 is coated with pyrotechnic material (not shown in FIG. 2). For example, the inner surface 67 may be coated with an amount of pyrotechnic material in the range of 5 mg/m length to 100 mg/m length, particularly in the range of 10 mg/m length to 85 mg/m length or in the range of 15 mg/m length to 70 mg/m length. As an alternative to the ignition hose 61, it is also conceivable to use an ignition cord surrounded by a metal tube to protect the surrounding components.

The connection between the trigger 7 and the ignition hose 61 as well as between the ignition hose 61 and the separating device 3 is identically formed in the embodiment of FIG. 2. However, it is also conceivable that the connections are configured differently. The housing 49 of the trigger 7 has a hollow cylindrical receptacle 69 around the opening 57, into which the end 63 of the ignition hose 61 is inserted in order to couple the ignition hose 61 to the trigger 7. For attaching the ignition hose 61 in the receptacle 69, the receptacle 69 has two circumferential projections 73 on an inner side 71, which engage in two circumferential grooves 75 on the ignition hose 61, which are adapted in shape thereto, and thus hold the latter form-fittingly in the receptacle 69. The separating device 3 also has a hollow cylindrical receptacle 77 around the opening 29, into which the other end 65 of the ignition hose 61 is inserted in order to couple the ignition hose 61 to the separating device 3. The receptacle 77 also has two circumferential projections 79 and the ignition hose 61 has two circumferential grooves 81 at the end 65 which are adapted in shape thereto.

A check valve 83 is arranged in the receptacle 77 of the separating device 3 for sealing between the ignition hose 61 and the separating device 3. The check valve 83 comprises a ball 85 which is preloaded by a spring 87 and is thus pressed from inside the housing it outwards against a bottleneck 89 of the receptacle 77. In the embodiment shown in FIG. 2, the spring 87 is supported against a wall 91 inside the housing 11, which separates a chamber 93 from the chamber 23 in which the check valve 83 is located. The check valve 83 prevents the resulting high internal pressure from being transmitted to the ignition hose 61 when the pyrotechnic drive 31 of the separating device 3 is triggered, thus ensuring that all of the energy generated by the pyrotechnic drive 31 is transferred to the cut mechanism 33 and that surrounding components are not damaged by the high internal pressure.

With regard to the exemplary embodiments shown in FIGS. 1 and 2, it should be noted that the pyrotechnic separating device 3, the pyrotechnic drive 31 and the system 1 are scalable in their dimensions, preferably in order to cut differently dimensioned (electrical) lines 5 or to provide differently sized pyrotechnic energy output quantities. Furthermore, their external shape, in particular cross-sectional dimension, is also not limited to a specific shape and/or dimension, but can be adapted depending on the application or installation situation, for example, of the pyrotechnic separating device 3 in or on an electrical device not shown. The through-channel 19 is to be dimensioned and thereby adapted to the external dimensions of the electrical line 5 in such a way that the electrical line 5 can be passed through the through-channel 19.

FIG. 2 shows the pyrotechnic separating system 10 according to the invention in an initial state in which the electrical energy source to be monitored is at normal temperature. When the energy source overheats and the temperature of the energy source exceeds a predetermined temperature threshold, the pyrotechnic separating device 3 is remotely activated by the system t according to the invention to cut the line 5 at a location spatially remote from the energy source, which is explained in detail below.

When the temperature of the electrical energy source detected by the pyrotechnic igniter 7 exceeds the predetermined temperature threshold, a non-electrical, purely pyrotechnic chain reaction is started to remotely activate the separating device 3. When the predetermined temperature threshold is exceeded, the ampoule 53 of the pyrotechnic igniter 7 breaks so that mixing of the reaction substance 55 and the reaction partner substance 51 within the housing 49 of the igniter 7 results in an exothermic chemical initial reaction that causes an pyrotechnic initial conversion to occur.

The exothermic chemical initial reaction cuts through the metal foil 59 that closes the opening 57 of the igniter 7, so that the pyrotechnic initial conversion causes a pyrotechnic transfer conversion in the ignition hose 61 under an exothermic chemical subsequent reaction. Due to the pyrotechnic material on the inner side 67 of the ignition hose 61, the transfer conversion is transferred at a speed of about 2000 m/s from the end 63 of the ignition hose 61 connected to the trigger 7 to the end 65 of the ignition hose 61 connected to the separating device 3.

The pyrotechnic transfer conversion causes a pyrotechnic ignition conversion in the separating device 3 at the end 65 of the ignition hose 61. The transfer conversion in the explosive hose 61 opens the check valve 83 by pushing the ball 85 into the interior of the housing 11 against the force of the spring 87, so that a flame passes through the opening 29 of the housing 11 into the chamber 23, which causes ignition of the pyrotechnic material 35 arranged in the chamber 23 there. After the transfer conversion, the spring 87 pushes the ball 85 back to its original position so that the chamber 23 is once again sealed to the outside. The sealing of the chamber 23 is thus only temporarily released during the pyrotechnic conversion of the ignition hose. 61.

The ignition of the pyrotechnic material 35 in the chamber 23 triggers the separation device 3 and moves the cut mechanism 33 in axial direction A, so that the cut mechanism 33 cuts the line 5.

The system 1 according to the invention thus makes it possible to monitor potentially overheated energy sources, which are installed in electronic components, for example, and to reliably separate them from the energy supply in the event of overheating, even if the electrical line 5 of the corresponding energy source is not directly accessible at the energy source itself or at the location of temperature detection, for example, due to installation space-related reasons. In this respect, it is possible with the system according to the invention to reliably separate energy sources and/or electrical devices in the event of overheating, irrespective of the available installation space and the installation space conditions.

The features disclosed in the foregoing description, figures, and claims may be significant, both individually and in any combination, for the realization of the invention in the various embodiments.

### LIST OF REFERENCE SIGNS

1 system
10 pyrotechnic separating system
100 pyrotechnic remote ignition system
3 pyrotechnic separating device
5 line
7 pyrotechnic igniter
9 pyrotechnic remote ignition means
11 housing
13 housing longitudinal side
15 bottom wall
17 distal edge section
19 through-channel
21 housing section
23 chamber
25 opening
27 primer
29 opening
31 pyrotechnic drive
33 cut mechanism
35 pyrotechnic material
37 piston
39 guide
41 sealing ring
43 line section
45, 47 line end
49 housing
51 reaction partner substance
53 Ampoule
55 reaction substance
57 opening
59 metal foil
61 ignition hose
63, 67 ignition hose end
67 inner surface
69 hollow cylindrical receptacle
71 receptacle inner side
73 circumferential projection
75 circumferential groove
77 hollow cylindrical receptacle
79 circumferential projection
81 circumferential groove
83 check valve
85 ball
87 spring
89 bottleneck
91 wall
93 chamber
101 pyrotechnic temperature sensor

1. A method of providing a predetermined pyrotechnic energy output to a pyrotechnic separating device for separating an electrical line, such as a cable, a wire, a conductor path or the like, leading to an electrical energy source, such as a battery or an accumulator, for outputting and/or receiving electrical energy, in which: a temperature of or in the vicinity of the electrical energy source is detected; and, when the detected temperature exceeds a predetermined temperature threshold, the pyrotechnic separating device is remotely activated to separate the electrical line at a location spatially remote from the electrical energy source.

2. The method according to claim 1, wherein the remote activation is performed by a non-electrical pyrotechnic, chain reaction.

3. The method according to claim 1, in which, when the detected temperature exceeds a predetermined temperature threshold, a pyrotechnic initial conversion occurs under an exothermic chemical initial reaction.

4. The method according to claim 3, in which the pyrotechnic initial conversion causes a pyrotechnic transfer conversion under an exothermic chemical subsequent reaction.

5. The method according to claim 4, in which the pyrotechnic transfer conversion for triggering the pyrotechnic separating device causes a pyrotechnic ignition conversion of the pyrotechnic separating device.

6. A system for providing a predetermined pyrotechnic energy output to a pyrotechnic separating device for separating an electrical line, such as a cable, a wire, a conductor path or the like, leading to an electrical energy source, such as a battery or an accumulator, for outputting and/or receiving electrical energy, comprising a pyrotechnic igniter, which is exposed to the temperature of the electrical energy source and which pyrotechnically converts at a predetermined temperature, and a separate, pyrotechnic remote ignition means coupled to the igniter and couplable to the separating device, which is configured to transfer the heat released during the pyrotechnic conversion of the igniter to the pyrotechnic separating device.

7. The system according to claim 6, wherein the remote ignition means comprises pyrotechnic material adjusted such as to pyrotechnically convert upon pyrotechnic conversion of the igniter to trigger the pyrotechnic separating device.

8. System according to claim 7, wherein the remote ignition means is non-electrically triggerable, formed as an ignition cord or as an ignition hose, wherein an inner side of the ignition hose is coated with pyrotechnic material.

9. A pyrotechnic separating system comprising a system according to claim 1 and a pyrotechnic separating device coupled to the remote ignition means for separating an electrical line, such as a cable, a wire, a conductor path or the like, leading to an electrical energy source, such as a battery or an accumulator, for outputting and/or receiving electrical energy.

10. Pyrotechnic separating system according to claim 9, wherein the pyrotechnic separating device has a housing with pyrotechnic material, which is sealed with respect to the remote ignition means in such a way that the seal is broken in particular exclusively during pyrotechnic conversion of the igniter, in particular of the remote ignition means.

11. Pyrotechnic separating system according to claim 10, wherein the seal is configured in such a way that upon triggering of the pyrotechnic separating device, the seal is rebuilt, wherein in particular the seal is implemented by a check valve.

12. Pyrotechnic separating system according to claim 9, wherein the pyrotechnic separating device has a cut mechanism for cutting the electrical line and a pyrotechnic drive for operating the cut mechanism, which is associated with the pyrotechnic drive in such a way that, upon activation of the pyrotechnic drive, the cut mechanism is driven, particularly wherein the pyrotechnic drive is equipped with a material which pyrotechnically converts as a function of temperature.

13. Pyrotechnic separating system according claim 9, wherein the remote ignition means and the pyrotechnic separating device and/or the remote ignition means and the igniter are coupled to one another in a force-fitting, form-fitting and/or material-fitting manner.

14. Pyrotechnic remote ignition system comprising a plurality of pyrotechnic temperature sensors which are associated with an electrical energy source, such as a battery or an accumulator, or a plurality of electrical energy sources which are connected to a common electrical line carrying electrical energy, and a pyrotechnic separating device which is spatially separated from the pyrotechnic temperature sensors, which is associated with the electrical line, such as a cable, a wire, a conductor path or the like, leading to the electrical energy source for outputting and/or receiving electrical energy, the pyrotechnical separating device being coupled to the pyrotechnical temperature sensors by remote ignition means in such a way that the pyrotechnical separating device is activated by one of the remote ignition means when the pyrotechnical temperature sensor associated with the remote ignition means triggers.

15. (canceled)

16. System according to claim 8, wherein the inner side of the ignition hose is coated with pyrotechnic material with an amount in the range from 5 mg/m length to 100 mg/m length.

17. System according to claim 8, wherein the inner side of the ignition hose is coated with pyrotechnic material with an amount in the range from 10 mg/m length to 85 mg/m length.

18. System according to claim 8, wherein the inner side of the ignition hose is coated with pyrotechnic material with an amount in the range from 15 mg/m length to 70 mg/m length.
